(19) United States
(12) Patent Application Publication
(10) Pub. No.: US 2008/0102283 A1
(43) Pub. Date: May 1, 2008

(54) Coating Composition and Structural Member of Automotive Body

(76) Inventors: Kazuo Momiyama, Tochigi-ken (JP); Kenji Suda, Hyogo-ken (JP); Yusuke Oka, Hyogo-ken (JP); Jyunichi Yoneta, Hyogo-ken (JP)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/794,350

(22) PCT Filed: Dec. 28, 2005
(86) PCT No.: PCT/JP05/24139

§ 371 Date: Jun. 28, 2007

(30) Foreign Application Priority Data
Dec. 28, 2004 (JP) 2004-379991

(51) Int. Cl. B32B 27/38; C08K 9/00

(52) U.S. Cl. 428/413; 523/206; 525/55

(57) ABSTRACT

There is provided a coating film applied onto structural members of automotive body, such as drive shaft, which coating film is formed by hardening of a coating composition comprising an epoxy resin powder coating material and at least either a polyolefin resin or a modified olefin resin containing a polar group. As the polyolefin resin or modified olefin resin containing a polar group, there can be selected those of 0.1 to 80 g/10 min melt index at 190° C. and −100° to −20° C. brittle temperature. In the coating composition, the ratio between epoxy resin powder coating material and polyolefin resin or modified olefin resin containing a polar group on a weight ratio basis is set for 1 to 70 : 99 to 30.

### TECHNICAL FIELD

The present invention relates to a coating composition for giving chipping resistance and an automotive body structural member (structural member of an automotive body) coated with such a coating composition.

### BACKGROUND ART

Automotive bodies include structural members near the road surface, e.g., floor panel lower surfaces and drive shafts, having a coating film of a cured coating composition. When pebbles and gravel that are thrown up by tires while the automobile is traveling hit the coating film, the coating film protects the area coated therewith to prevent the area from being damaged. Stated otherwise, the coating film functions as a protective film and hence is required to be resistant (chipping-resistant) to the collision with pebbles and gravel.

Epoxy resin coating compositions are widely used as the coating composition for forming the coating film because they are primarily made of an epoxy resin which adheres firmly to the workpiece and which has an excellent rust prevention capability. However, epoxy resin coating compositions are disadvantageous in that since their glass transition temperature is relatively high, they are brittle in cold climate and cannot easily achieve chipping resistance, and in addition they have a relatively high water absorption rate.

Patent Document 1, for example, proposes a powder coating composition comprising a solid powder containing an olefinic resin, a solid powder containing a polar-group modified olefinic resin, and a solid powder containing an epoxy resin. The document states that the powder coating composition forms a multilayer coating film having a lower layer of a cured epoxy resin and a surface layer in the form of an olefinic resin film.

Patent Documents 2, 3 disclose a coating film on an outer surface of a steel pile, the coating film having a lowermost layer of an epoxy powder coating compound, an intermediate layer of an adhesive polyolefin having a polar group, and an uppermost layer of a polyolefin.

It is also proposed in Patent Documents 4, 5 to provide a coating film having an epoxy powder coating compound and a polyolefin resin that are laminated together or semi-interpenetrated.

Patent Document 1: Japanese Patent Publication No. 62-27109;

Patent Document 2: Japanese Laid-Open Patent Publication No. 2-8043;

Patent Document 3: Japanese Laid-Open Patent Publication No. 63-258680;

Patent Document 4: Japanese Laid-Open Patent Publication No. 11-513416 (PCT Application); and

Patent Document 5: Japanese Patent Publication No. 62-27109.

### DISCLOSURE OF THE INVENTION

As described above, various proposals have been made to combine polyolefinic coating compositions for improving the properties of the epoxy-resin coating composition. However, either one of the polyolefinic coating compositions does not have highly excellent chipping resistance in low-temperature environments. There are still demands for a coating composition having better chipping resistance.

It is a major object of the present invention to provide a coating composition having better chipping resistance in low-temperature environments.

Another object of the present invention is to provide an automotive body structural member coated with the above coating composition.

According to an aspect of the present invention, there is provided a coating composition comprising an epoxy resin powder coating compound and at least one of a polyolefinic resin and a polar-group modified olefinic resin having affinity with an epoxy resin, wherein the polyolefinic resin or the polar-group modified olefinic resin has a melt index at 190° C. in a range from 0.1 to 80 g/10 minutes and a brittle temperature in a range from −100° C. to −20° C., and the epoxy resin powder coating compound has a proportion in a range from 1 to 70 parts by weight and the at least one of the polyolefinic resin and the polar-group modified olefinic resin has a proportion in a range from 99 to 30 parts by weight.

According to the present invention, the epoxy resin powder coating compound and at least one of the polyolefinic resin and the polar-group modified olefinic resin which can be physically bonded to the epoxy resin are mixed into the coating composition. The coating composition exhibits firm adhesion to a workpiece because of the epoxy resin, and exhibits excellent corrosion resistance and water resistance. The coating composition also exhibits good chipping resistance even in low-temperature environments because of the polyolefinic resin or the polar-group modified olefinic resin.

Therefore, according to the present invention, there is provided a coating film which adheres firmly to a workpiece, and exhibits excellent corrosion resistance, excellent water resistance and chipping resistance. The workpiece coated with the coating film is protected for increased durability.

In the present invention, “affinity” is defined as a property which makes different materials physically and/or chemically attracted to each other. An example of affinity includes a hydrogen bond, a bond by van der Waals force, or the like.

A preferred example of the polar-group modified olefinic resin may be a modified olefinic resin having a carboxyl group as a polar group. Such a polar group may be introduced by copolymerization or graft polymerization of a vinyl monomer containing a carboxyl group, unsaturated carboxylic acid, or an anhydride thereof. Specific examples of such a polar substance include acrylic acid, methacrylic acid, vinyl acetate, maleic acid anhydride, maleic acid, etc.

The epoxy resin powder coating compound should preferably contain an epoxy resin having a softening point in a range from 30° C. to 160° C. The epoxy resin powder coating compound containing such an epoxy resin has an excellent handling capability at normal temperature, and can easily be kneaded.

According to another aspect of the present invention, there is provided an automotive body structural member having a coating film of a cured coating composition comprising 1 to 70 parts by weight of an epoxy resin powder coating compound and 99 to 30 parts by weight of at least one of a polyolefinic resin and a polar-group modified olefinic resin, wherein the polyolefinic resin or the polar-group modified olefinic resin has a melt index at 190° C. in a range from 0.1 to 80 g/10 minutes and a brittle temperature in a range from −100° C. to −20° C., and the polar-group modified olefinic resin includes a polar group having affinity with an epoxy resin.

The automotive body structural member of the above structure is protected by the coating film even when hit by pebbles and gravel. Therefore, the automotive body structural member is prevented from being damaged. Since the coating film has good corrosion resistance and water resistance, no rust is produced on the automotive body structural member. As a consequence, the automotive body structural member is less liable to be damaged even in low-temperature environments and is less liable to the development of rust.

The automotive body structural member is not limited to any particular structural member, but may preferably comprise a drive shaft, a floor panel, or various springs (ex. a spring of a suspension).

As described above, the polar-group modified olefinic resin may have a carboxyl group as a polar group, for example. The epoxy resin powder coating compound should preferably contain an epoxy resin having a softening point in a range from 30° C. to 160° C.

### BRIEF DESCRIPTION OF THE DRAWINGS

FIG. 1 is a systematic view of a power transmitting mechanism incorporating a drive shaft which has a coating film of a coating composition according to an embodiment of the present invention; and

FIG. 2 is a table showing, for comparison, properties of Inventive Examples 1 through 4 and Comparative Examples 1, 2.

### BEST MODE FOR CARRYING OUT THE INVENTION

A coating composition according to a preferred embodiment of the present invention will be described in detail below with reference to the accompanying drawings in relation to an automotive body structural member coated with the coating composition.

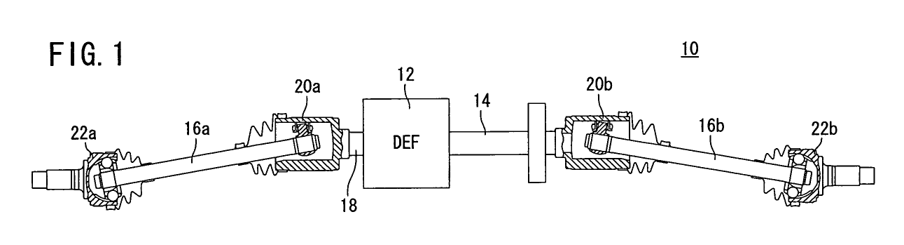

A drive power transmitting mechanism for transmitting the drive power from an engine to tires is shown in FIG. 1. The drive power transmitting mechanism, denoted by 10, includes a half shaft 14 and splined shafts 16a, 16b connected successively from a differential gear 12, the splined shafts 16a, 16b being connected to hubs over which wheels are fitted (both not shown).

A rotational shaft 18 of the differential gear 12 and the half shaft 14 are connected respectively to the splined shafts 16a, 16b by tripod constant velocity universal joints 20a, 20b. The splined shafts 16a, 16b are connected to the respective hubs by Barfield constant velocity universal joints 22a, 22b. The rotational drive power from the engine is transmitted through the differential gear 12, the tripod constant velocity universal joints 20a, 20b, the half shaft 14 and the rotational shaft 18, the splined shafts 16a, 16b, the Barfield constant velocity universal joints 22a, 22b, and the hubs to the tires (not shown).

A coating film is formed on the surface of each of the half shaft 14 and the splined shafts 16a, 16b, i.e., drive shafts. The coating film is formed upon curing of a coating composition containing an epoxy resin powder coating compound and at least one of a polyolefinic resin and a polar-group modified olefinic resin.

The epoxy resin powder coating compound contains an epoxy resin, a curing agent, a pigment, and various additives. The epoxy resin should preferably have an epoxy equivalent weight in a range from 170 to 2100 g/eq., and more preferably in a range from 600 to 1200 g/eq.

The epoxy resin should preferably have a softening point in a range from 30° C. to 160° C. If the softening point is lower than 30° C., then it is difficult for the epoxy resin to remain solid at normal temperature, thus resulting in difficulty producing a powder coating compound. If the softening point is higher than 160° C., then the epoxy resin will not easily be softened in a kneading process to be described later. The epoxy resin should more preferably have a softening point in a range from 50° C. to 150° C., and more preferably in a range from 60° C. to 140° C.

The epoxy resin which meets the above requirements is easily available as commercial products such as Epikote 1004 (a trade name of Japan Epoxy Resins Co., Ltd.), Epototo YDO14 (a trade name of Tohto Kasei Co., Ltd.), Epiclon 4050 (a trade name of Dainippon Ink and Chemicals, Inc.), etc.

The curing agent is not limited to any particular substances insofar as it can cure an epoxy resin. Preferable examples, however, include amine, amidine, acid anhydride, phenol having a novolak structure, phenol having a skeleton of bisphenol epoxy, diaminodiphenyl methane (DDM), adipic acid dihydrazide (ADH), and any of these substances to which an imidazole or its derivative is added.

If the total weight of the epoxy resin powder coating compound represents 100 weight %, then it is sufficient for the curing agent to have a proportion in a range from 1 to 20 weight %.

The pigment may be any of pigments that are in general use. Specifically, a coloring pigment of the pigment may be titanium oxide, red iron oxide, yellow iron oxide such as ochre or the like, carbon black, quinacridone, azo compound, dioxane, threne, a metal complex such as phthalocyanine or the like, or any of various metal salts. Also, an extender pigment of the pigment may be barium sulfate, silicon dioxide, talc, calcium carbonate, potassium titanate whisker, aluminum borate whisker, wollastonite, aluminum oxide, or any of other ceramics powders.

The pigment is not an indispensable component. If the pigment is added, then it should preferably be added in a range from 1 to 80 weight % and more preferably in a range from 10 to 80 weight % if the total weight of the epoxy resin powder coating compound represents 100 weight %.

The additives include a leveling agent, wax, a debubbling agent, an antioxidizing agent, an ultraviolet absorbent, etc. The additives are not indispensable components. If the additives are added, then they should preferably be added in a range from 0.1 to 10 weight % and more preferably in a range from 0.3 to 7 weight % if the total weight of the epoxy resin powder coating compound represents 100 weight %.

The polyolefinic resin is selected from those polymerized olefinic monomers whose melt index at 190° C. is in a range from 0.1 to 80 g/10 minutes. If the melt index is smaller than 0.1 g/10 minutes, then it is difficult to obtain a smooth coating film because the coating composition develops no sufficient flowability when baked after being applied. If the melt index is greater than 80 g/10 minutes, then though the leveling ability increases, the brittle temperature rises, lowering the chipping resistance in low-temperature environments. Polyolefinic resins whose melt indexes are in a range from 0.15 to 50 g/10 minutes are preferable, and polyolefinic resins whose melt indexes are in a range from 0.2 to 30 g/10 minutes are more preferable.

Furthermore, the polyolefinic resin is selected from those which have a brittle temperature in a range from −100° C. to −20° C. If the brittle temperature exceeds −20° C., then the chipping resistance in low-temperature environments is not sufficient. If the brittle temperature is lower than −100° C., then it is difficult to crush the polyolefinic resin.

The polyolefinic resin of the above properties may be replaced with a polar-group modified olefinic resin. Of course, both a polyolefinic resin and a polar-group modified olefinic resin may simultaneously be included.

The polar-group modified olefinic resin is selected from those which have a melt index at 190° C. in a range from 0.1 to 80 g/10 minutes and which have a brittle temperature in a range from −100° C. to −20° C., as with the polyolefinic resin. The reasons for this have been described above.

The polar group of the polar-group modified olefinic resin is a functional group which exhibits affinity with an ethylene resin, and may specifically be a carboxyl group, for example. Preferable examples of a polar-group modified olefinic resin having such a functional group are ADMER, UM1420, and FLO-THENE 13142. ADMER refers to the trade name of a low-density polyethylene resin manufactured by Mitsui Chemicals, Inc., and has a melt index of 9 g/10 minutes at 190° C. and a brittle temperature of −60° C. or lower. UM1420 and FLO-THENE 13142 refer to the respective trade names of a low-density polyethylene resin for fluidized bed dip coating manufactured by Ube Industries, Ltd., and a low-density polyethylene resin for electrostatic coating manufactured by Sumitomo Seika Chemicals Co., Ltd., and have respective melt indexes of 20 g/10 minutes and 10 g/10 minutes at 190° C. and respective brittle temperatures of −70° C. or lower and −80° C. or lower.

The polyolefinic resin and the polar-group modified olefinic resin may be colored by carbon black or the like.

The epoxy resin powder coating compound and at least one of the polyolefinic resin and the polar-group modified olefinic resin have respective weight ratios in a range from 1 to 70 and in a range from 99 to 30. If the proportion of the polyolefinic resin or the polar-group modified olefinic resin is less than 30 parts by weight, then the chipping resistant at about −40° C. is not sufficient. If the proportion of the polyolefinic resin or the polar-group modified olefinic resin is in excess of 99 parts by weight, then it is difficult to form a coating film having a uniform surface.

The coating film is produced from the coating composition of the above components as follows:

First, the epoxy resin powder coating compound is prepared. Specifically, the epoxy resin, the curing agent, and the additives referred to above are mixed at normal temperature, and kneaded by a kneader that is generally used for manufacturing a powder coating compound, such as a uniaxial extruder, a biaxial extruder, or the like. Pellets that are formed by the kneader are pulverized by a mill such as a pin mill or the like into a powder having a particle diameter of 200 μm or less, for example. The particle size distribution of the powder is brought into a predetermined range by a sieve or the like.

The polyolefinic resin or the polar-group modified olefinic resin or their mixture is pulverized at normal temperature or at a temperature below the freezing point into a power having a particle diameter of 300 μm or less, for example. The particle size distribution of the powder may also be brought into a predetermined range by a sieve or the like.

The powders thus obtained are mixed such that the epoxy resin powder coating compound has a proportion in a range from 1 to 70 parts by weight and at least one of the polyolefinic resin and the polar-group modified olefinic resin has a proportion in a range from 99 to 30 parts by weights, thereby producing a coating composition. The coating film is produced by coating the half shaft 14 and the splined shafts 16a, 16b with the coating compound according to electrostatic coating, fluidized bed dip coating, in-mold coating, or the like, and baking the assemblies in a hot-air oven, an infrared oven, or an induction heating oven to cure the coating compound.

When the coating compound is cured, phase separation occurs between the epoxy resin powder coating compound and the polyolefinic resin or the polar-group modified olefinic resin.

The coating film thus produced adheres firmly to the workpieces (the half shaft 14 and the splined shafts 16a, 16b) because of the epoxy resin, and exhibits excellent corrosion resistance and water resistance. The coating film also exhibits good chipping resistance even in low-temperature environments because of the polyolefinic resin or the polar-group modified olefinic resin.

Automotive body structural members on which the coating film is to be formed are not limited to the half shaft 14 and the splined shafts 16a, 16b, but may be floor panels, not shown, or spiral springs or leaf springs of suspensions, not shown.

Furthermore, workpieces to be coated with the coating composition are not limited to automotive body structural members.

### INVENTIVE EXAMPLE 1

100 parts by weight of Epiclon 4050 (Dainippon Ink and Chemicals, Inc., epoxy equivalent weight: 945 g/eq, softening point: 100° C.), 6 parts by weight of ADH as a curing agent, 20 parts by weight of barium sulfate, 1.5 parts by weight of carbon black, and 2 parts by weight of BYK360P as an acrylic leveling agent were prepared, preliminarily mixed by a high-speed mixer, thereafter kneaded, pulverized, and classified to produce an epoxy resin powder coating compound having an average particle diameter of 50 μm.

Commercially available ADMER NS101 was prepared as a powder having an average particle diameter of 180 μm.

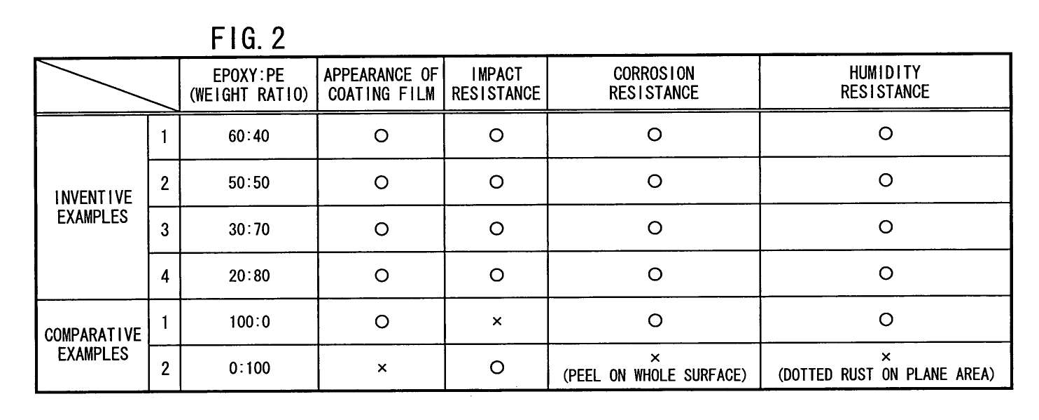

Then, both powders were mixed at proportions shown in FIG. 2, producing coating compositions. The coating compositions were electrostatically applied to shot-blasted mild steel panels (having a thickness of 6 mm). The applied coating compositions were cured by being held at 180° C. for 20 minutes, whereupon smooth coating films having a thickness of about 100 μm were produced. They were labeled as Inventive Examples 1 through 4.

For comparison, coating films were formed respectively from the above epoxy resin powder coating compound and ADMER NS101 (powdery) under the same conditions as with Inventive Examples 1 through 4. They were labeled as Comparative Examples 1, 2.

The coating films according to Inventive Examples 1 through 4 and Comparative Examples 1, 2 were evaluated for appearance, impact resistance, corrosion resistance, and moisture resistance. The appearance was visually judged. If the appearance was acceptable, it was indicated as “◯”, and if the appearance was defective, it was indicated as “x”. The impact resistance was judged by holding the mild steel panels at −40° C. for 24 hours, thereafter removing the mild steel panels, and testing them according to JIS K 5600 5-3-6. Specifically, a punch having a diameter of ⅛ inch and a weight of 1 kg were used, and the weight was dropped from a height of 50 cm above the mild steel panels onto them. Those mild steel panels with coating films uncracked were indicated as “◯”, and those mild steel panels with coating films cracked were indicated as “x”. The better the impact resistance, the better the chipping resistance at a low temperature.

The corrosion resistance was evaluated by spraying salt water, for 500 hours, to the coating films which have a x-shaped mark cut therein, thereafter applying a tape to the coating films, peeling off the tape, and then observing if there was a peel-off of the coating films or not, according to JIS K 5600 7-1. If the width of a peel-off from the cut mark is 1 mm or less, the coating film was indicated as “◯”. If the coating film was peeled off over 1 mm, then it was indicated as “x”.

The humidity resistance was evaluated by a test conducted according to JIS K 5600 7-2 which prescribes a continuous condensation method. Specifically, the mild steel panels were removed from the moisture environment after 500 hours and visually checked for their appearance. One hour later after taking the panels out of a moisture box, the cross-cut-peeling test was done on the humidity tested panels, and then judged. In the cross-cut-peeling test, according to JIS K 5600 5-6, an adhesive tape was applied to a cross-cut area of each of the mild steel panels, which was divided into 100 units each of 1 mm×1 mm, and then peeled off. The coating films were evaluated by checking how much of the cross-cut area had stuck to the adhesive tape.

If the coating film was smooth and the result of adhesion test was 100/100, then the coating film was indicated as “◯”, and if the coating film was not smooth and many craters were produced in the cross-cut-peeling test, then the coating film was indicated as “x”.

The above evaluated results are shown in FIG. 2. It can be seen from FIG. 2 that a coating film which has a good appearance, excellent chipping resistance in low-temperature environments, excellent corrosion resistance, and excellent humidity resistance can be formed by mixing an epoxy resin powder coating compound and at least one of a polyolefinic resin and a polar-group modified olefinic resin.

As shown in FIG. 2, the coating film made of only ADMER NS101 had many pinholes and a poor appearance. The adhesion of the coating film to the mild steel panel was not highly sufficient, and the corrosion resistance and the humidity resistance of the coating film were insufficient.

1. A coating composition comprising:
an epoxy resin powder coating compound; and
at least one of a polyolefinic resin and a polar-group modified olefinic resin having affinity with an epoxy resin;
wherein said polyolefinic resin or said polar-group modified olefinic resin has a melt index at 190° C. in a range from 0.1 to 80 g/10 minutes and a brittle temperature in a range from −100° C. to −20° C.; and
said epoxy resin powder coating compound has a proportion in a range from 1 to 70 parts by weight and said at least one of said polyolefinic resin and said polar-group modified olefinic resin has a proportion in a range from 99 to 30 parts by weight.

2. A coating composition according to claim 1, wherein said polar-group modified olefinic resin has a carboxyl group as a polar group.

3. A coating composition according to claim 1, wherein said epoxy resin powder coating compound contains an epoxy resin having a softening point in a range from 30° C. to 160° C.

4. A coating composition according to claim 1, wherein said epoxy resin powder coating compound contains an epoxy resin having an epoxy equivalent weight in a range from 170 to 2100 g/eq.

5. A coating composition according to claim 1, wherein said epoxy resin powder coating compound contains at least one of a curing agent, a pigment, and an additive.

6. A coating composition according to claim 5, wherein said curing agent is selected from the group of substances including amine, amidine, acid anhydride, phenol having a novolak structure, phenol having a skeleton of bisphenol epoxy, diaminodiphenyl methane, adipic acid dihydrazide, and any of these substances to which an imidazole or an imidazole derivative is added.

7. A coating composition according to claim 5, wherein said pigment comprises at least one of titanium oxide, red iron oxide, ochre, carbon black, quinacridone, azo compound, dioxane, threne, phthalocyanine, barium sulfate, silicon dioxide, talc, calcium carbonate, potassium titanate whisker, aluminum borate whisker, wollastonite, and aluminum oxide.

8. A coating composition according to claim 5, wherein said additive comprises at least one of a leveling agent, wax, a debubbling agent, an antioxidizing agent, and an ultraviolet absorbent.

9. An automotive body structural member having a coating film of a cured coating composition comprising 1 to 70 parts by weight of an epoxy resin powder coating compound and 99 to 30 parts by weight of at least one of a polyolefinic resin and a polar-group modified olefinic resin;
wherein said polyolefinic resin or said polar-group modified olefinic resin has a melt index at 190° C. in a range from 0.1 to 80 g/10 minutes and a brittle temperature in a range from −100° C. to −20° C.; and
said polar-group modified olefinic resin includes a polar group having affinity with an epoxy resin.

10. An automotive body structural member according to claim 9, wherein said polar-group modified olefinic resin has a carboxyl group as a polar group.

11. An automotive body structural member according to claim 9, wherein said epoxy resin powder coating compound contains an epoxy resin having a softening point in a range from 30° C. to 160° C.

12. An automotive body structural member according to claim 9, wherein said epoxy resin powder coating compound contains an epoxy resin having an epoxy equivalent weight in a range from 170 to 2100 g/eq.

13. An automotive body structural member according to claim 9, wherein said epoxy resin powder coating compound contains at least one of a curing agent, a pigment, and an additive.

14. An automotive body structural member according to claim 13, wherein said curing agent is selected from the group of substances including amine, amidine, acid anhydride, phenol having a novolak structure, phenol having a skeleton of bisphenol epoxy, diaminodiphenyl methane, adipic acid dihydrazide, and any of these substances to which an imidazole or an imidazole derivative is added.

15. An automotive body structural member according to claim 14, wherein said pigment comprises at least one of titanium oxide, red iron oxide, ochre, carbon black, quinacridone, azo compound, dioxane, threne, phthalocyanine, barium sulfate, silicon dioxide, talc, calcium carbonate, potassium titanate whisker, aluminum borate whisker, wollastonite, and aluminum oxide.

16. An automotive body structural member according to claim 14, wherein said additive comprises at least one of a leveling agent, wax, a debubbling agent, an antioxidizing agent, and an ultraviolet absorbent.

17. An automotive body structural member according to claim 9, wherein said automotive body structural member comprises any one of a drive shaft, a floor panel, and a spring of a suspension.
